(19) United States
(12) Patent Application Publication
(10) Pub. No.: US 2018/0246339 A1
(43) Pub. Date: Aug. 30, 2018

(54) GREEN LASER FOR DISPLAY APPLICATIONS

(71) Applicant: UNIVERSITY OF ROCHESTER, Rochester, NY (US)

(72) Inventor: John R. Marciante, Webster, NY (US)

(73) Assignee: UNIVERSITY OF ROCHESTER, Rochester, NY (US)

(21) Appl. No.: 15/755,276

(22) PCT Filed: Sep. 12, 2016
(86) PCT No.: PCT/US2016/051274

§ 371 Date: Feb. 26, 2018

Related U.S. Application Data
(60) Provisional application No. 62/218,830, filed on Sep. 15, 2015.

(51) Int. Cl. G02B 27/48; H01S 3/16; H01S 3/08; H01S 3/067; H01S 3/06; H01S 3/23; H01S 3/094; H01S 3/0941

(52) U.S. Cl. CPC G02B 27/48; H01S 3/1605; H01S 3/08063; H01S 3/06737; H01S 3/08086; H01S 3/0675; G03B 21/2033; H01S 3/08027; H01S 3/2391; H01S 3/0623; H01S 3/094007; H01S 3/1655; H01S 3/0941; H01S 3/0602

(57) ABSTRACT

Methods and apparatus for producing high power lasers with reduced speckle are provided. Fiber and solid-state lasers comprising terbium-doped lasing material are provided. Embodiments are described for increasing signal reflection bandwidth, reducing coupling and coherency of spatial modes, and equalizing gain of terbium-doped lasers for use in laser display systems. Spectral selectors are described for generating separate wavelengths within a range of interest for use in 3D laser display systems.

### CROSS-REFERENCE TO RELATED APPLICATION

This application claims priority to U.S. Provisional Application No. 62/218,830, filed Sep. 15, 2015, which is incorporated herein by reference in its entirety.

### BACKGROUND

Laser based display systems such as digital laser cinema (DLC) projectors often require high power lasers operating in the red, green, and blue bands of the visible light spectrum. In many instances, it is desirable that lasers used in such laser based display systems have an output power in the range of 10 to 100 W, but also be free of speckle, which is a granular pattern on the screen of a laser display that degrades image quality. Speckle typically results from the interference of components of a coherent light source that become de-phased due to roughness of the illuminated surface. Currently, high-power lasers in both red and blue bands are available as semiconductor diode lasers. Such lasers are low-cost and high-efficiency, with poor spatial coherence and sufficient spectral width to inherently mitigate speckle. In spite of the advances in power and reliability achieved over the last decade in the red and blue bands, similar quality diode lasers in the green band have been unachievable due to physical mechanisms in the materials and fabrication processes. Although the DLC projector market is sufficiently strong to drive the diode laser costs down to commodity levels, it has not promoted significant research and development efforts at solving the problems with the physical mechanisms in green diode lasers. For this reason, alternative methods are currently being used to generate light in the green band.

One currently employed method is to use a high-power laser directly emitting light in the infrared band and use a frequency doubling technique to generate the green band. However, frequency doubling requires the laser source to have a narrow spectrum. Accordingly, a mechanism separate from the laser components must be employed to eliminate speckle. For example, in such frequency doubling methods, a phase modulator may be used to spread the spectrum by generating discreet spectral sidebands, either in the infrared band before frequency doubling (each sideband doubling on its own) or after frequency doubling. Such alternate mechanisms require expensive components and add system complexity. For example, the required phase modulator and electrical RF driver for such mechanisms can be expensive and add unwanted complexity to a laser display. Moreover, such alternate mechanisms create an additional and less desirable failure mode wherein the entire system performance is compromised with the loss of any single component in the conversion process. Specifically, any resultant speckle in such a system would severely degrade the quality of the projected images, greatly distracting the viewer. In contrast, when a desired colored light is directly emitted by the diode laser, failure of a single diode laser simply results in the power in that color band reduced by a fractional amount. While this type of failure results in color rendering that is not strictly correct, it is still viewable without much distraction to the viewer. In addition, this latter type of failure can immediately be compensated by increasing the power to the other diode lasers. For example, more diode lasers than are necessary may be used and run below maximum power to allow headroom for power increase in the event of a single or multiple diode laser failure.

Therefore, what is needed is a new method of lasing that mitigates the problems with existing laser technologies for producing light for use in laser display systems.

### SUMMARY

The following presents a simplified summary of some non-limiting embodiments of the invention in order to provide a basic understanding of the invention. This summary is not an extensive overview of the invention. It is not intended to identify key/critical elements of the invention or delineate the scope of the invention. Its sole purpose is to present some embodiments of the invention in a simplified form as a prelude to the more detailed description that is presented later.

Methods and apparatus, as described herein, mitigate the problems with existing laser technologies for producing light of a desired band of wavelengths for use in laser display systems. In some non-limiting examples, a new type of diode-pumped laser that emits directly in the desired band of wavelengths with high efficiency and reduced speckle is described. In one non-limiting example, the laser medium is defined by terbium-doped material. Some non-limiting embodiments are described that address operating at high power in a band of wavelengths corresponding to green light with reduced speckle.

In one non-limiting embodiment, a laser comprising a terbium-doped lasing material is provided. The laser further comprises a first reflector positioned at a first end of the laser cavity, an output coupler positioned at a second end of the laser cavity, and a pump configured to pump the laser cavity such that the terbium-doped lasing material emits light.

In some instances, the first reflector comprises a high reflectivity for at least some wavelengths of the emitted light. For example, in some instances the first reflector comprises a reflectivity of at least 90% for at least some wavelengths of light. In some instances, the first reflector comprises a reflectivity of at least 98% for at least some wavelengths of light.

In some instances, the first reflector comprises a broad signal reflection bandwidth. For example, in some instances, the first reflector comprises a signal reflection bandwidth greater than 0.5 nm. In some instances, the first reflector comprises a signal reflection bandwidth greater than 5 nm. In some instances, the first reflector comprises a signal reflection bandwidth greater than 5 nm and less than 15 nm. In some instances, the signal reflection bandwidths include a 545 nm band. In some instances, the emitted light comprises a bandwidth greater than 5 nm and less than 15 nm

In some non-limiting embodiments, the laser is a fiber laser. In some instances, the fiber laser is a dual-clad fiber laser.

In some instances, the laser is a multi-core fiber laser comprising a plurality of spaced apart terbium-doped fiber cores. In some instances, the plurality of terbium-doped fiber cores are spaced apart such that less than −20 dB of the power of one of the cores overlaps with a neighboring core.

In some instances, the terbium-doped lasing material comprises a multimode fiber core. In some instances, the output coupler comprises a fiber Bragg grating configured such that different modes of the multimode fiber core lase at different wavelengths. In some instances, at least a first mode of the multimode fiber core is configured to lase at a first wavelength, a second mode of the multimode fiber core is configured to lase at a second wavelength different from the first wavelength, and a third mode of the multimode fiber core is configured to lase at a third wavelength different from the first and second wavelengths. In some instances, the first reflector comprises a signal reflection bandwidth including the first, second and third wavelengths. In some instances, the first reflector comprises a spectral reflection that spatially varies.

In some non-limiting embodiments, the laser is a solid-state laser. In some instances, the lasing material comprises one of a glass, a ceramic, and a crystalline material.

In some instances, the laser is a multimode solid-state laser. In some instances, the output coupler is configured such that different modes of the multimode laser lase at different wavelengths. In some instances, at least a first mode of the multimode solid-state laser is configured to lase at a first wavelength, a second mode of the multimode solid-state laser is configured to lase at a second wavelength different from the first wavelength, and a third mode of the multimode solid-state laser is configured to lase at a third wavelength different from the first and second wavelengths. In some instances, the first reflector comprises a signal reflection bandwidth including the first, second and third wavelengths.

In some instances, the output coupler comprises a spectral reflection that spatially varies. In some instances, the spectral reflection of the output coupler increases from a centerpoint of the output coupler towards an outer edge of the output coupler. In some instances, the spectral reflection is digitally patterned to increase from the centerpoint towards the outer edge, wherein the spectral reflection comprises an azimuthally averaged spectral reflection. In some instances, the laser further comprises a transmission filter that spatially varies. In some instances, the transmission filter comprises a pattern on the output coupler. In some instances, the transmission filter comprises an array of a plurality of spokes attached at the center of the filter and extending to an outer edge of the filter. In some instances, the size of each of the plurality of spokes changes from the center of the filter to the outer edge of the filter.

In some instances, the laser further comprises at least one imaging element configured to transform beams of light in the laser cavity so as to reduce coupling between different modes of the multimode laser. In some instances, the at least one imaging element is configured to Fourier transform beams of light in the laser cavity. In some instances, at least one imaging element comprises at least one of a lens, a curved mirror, and a diffractive optical element.

In another non-limiting embodiment, a laser comprising a laser cavity and a spectral shaping element is provided. The laser cavity comprises a terbium-doped lasing material, the terbium-doped lasing material comprising a spectrally dependent variable gain. The spectral shaping element is configured to compensate at least a portion of the spectrally dependent variable gain of the lasing material.

In some instances, the spectral shaping element is at least one of an intra-cavity filter, a coating on an end of an optical fiber, or a fiber Bragg grating.

In some instances, the spectral shaping element comprises a fiber Bragg grating reflector positioned at a first end of the laser cavity and a fiber Bragg grating output coupler positioned at a second end of the laser cavity.

In some instances, the spectral shaping element is configured to compensate at least a portion of spectrally dependent variable gain of the lasing material such that a net gain of the lasing material is substantially uniform over a band of wavelengths of interest. In some instances, the band of wavelengths of interest is 535-560 nm. In some instances, the band of wavelengths of interest corresponds to a peak of the spectrally dependent variable gain.

In some instances, the laser further comprises a plurality of spectral shaping elements, wherein each of the plurality of spectral shaping elements is configured to compensate a respective portion of the spectrally dependent variable gain of the lasing material such that a net gain of the lasing material is substantially uniform over a band of wavelengths of interest.

In some instances, the laser is a solid-state laser, and wherein the spectral shaping element is at least one of an intra-cavity filter, a coating on an end of the lasing material, or a volume Bragg grating.

In another non-limiting embodiment, a laser system comprising at least one laser cavity, a first spectral selector element, and a second spectral selector element is provided. The at least one laser cavity comprises a terbium-doped lasing material, the terbium-doped lasing material comprising a gain bandwidth. The first spectral selector element is configured to generate a first band from the gain bandwidth, and the second spectral selector element configured to generate a second band from the gain bandwidth, the second band being distinct from the first band.

In some instances, the laser system comprises a first laser comprising the at least one laser cavity and the first spectral selector, and a second laser comprising a second laser cavity comprising a terbium-doped lasing material and the second spectral selector.

In some instances, each of the spectral selector elements is at least one of an intra-cavity filter, a coating on an end of an optical fiber, a fiber Bragg grating, or a volume Bragg grating.

In some instances, the terbium-doped lasing material comprises a spectrally dependent variable gain, and the laser system further comprises a first spectral shaping element and a second spectral shaping element. The first spectral shaping element is configured to compensate at least a first portion of the spectrally dependent variable gain of the lasing material such that a net gain of the lasing material is substantially uniform over the first band. The second spectral shaping element is configured to compensate at least a second portion of the spectrally dependent variable gain of the lasing material such that a net gain of the lasing material is substantially uniform over the second band.

In some instances, the laser system is configured to be used in a digital laser display for reproducing three-dimensional images.

In another non-limiting embodiment, a digital laser display comprising a plurality of lasers is provided. The plurality of lasers are usable to display images, wherein each of the plurality of lasers is configured to emit light within a distinct band of wavelengths. At least one of the plurality of lasers comprises a laser cavity comprising a terbium-doped lasing material, a first reflector positioned at a first end of the laser cavity, an output coupler positioned at a second end of the laser cavity, and a pump configured to pump the laser cavity such that the terbium-doped lasing material emits light within a desired band of wavelengths, wherein the emitted light has a speckle contrast of less than 12%.

In some instances, the desired band of wavelengths is 535-560 nm.

### BRIEF DESCRIPTION OF THE DRAWINGS

FIG. 1 shows the atomic transition for Rare Earth ions.

FIG. 2 shows the photoluminescence emission spectrum from terbium-doped silicate glass when pumped at a wavelength of 488 nm.

FIG. 3 is a schematic example of a broadband terbium-doped fiber laser.

FIG. 4 shows an example of a cross-section of a multicore dual-clad fiber laser.

FIG. 5 is a schematic example of a broadband terbium-doped solid state laser.

FIG. 6 graphically illustrates spectral reflection peaks for one example of an FBG written in multimode fiber.

FIG. 7 graphically illustrates an example of a spectral reflection that varies with the radial dimension in a coating at the end of a fiber.

FIG. 8 shows examples of radial reflection profiles of spatially engineered reflectors whose reflectivity increases from a center towards an outer edge.

FIG. 9 shows an example of a hexagonally digitally patterned reflector with azimuthally averaged reflectivity that increases from the center of the reflector to the outer edge.

FIG. 10 shows examples of spatially engineered transmission filters containing arrays of blocking spokes attached from the center of the filters to the edges.

FIG. 11(a) shows a transverse cross section of beams of different spatial modes inside a gain medium of a multimode laser.

FIG. 11(b) shows a transverse cross section of beams of different spatial modes inside a gain medium of a Fourier Transformed multimode laser.

FIG. 12(a) shows a schematic of an example of a solid-state laser resonator cavity.

FIG. 12(b) shows a schematic of an example of a an FT laser.

FIG. 13 shows an example of a gain equalization strategy.

FIG. 14 shows an example of a gain equalization strategy.

FIG. 15 shows an example of a gain equalization strategy near a gain peak.

FIG. 16 shows an example of a gain equalization strategy with a segmented spectrum.

FIG. 17 shows an example of two spectral selectors for selecting two separate green colors in terbium-doped lasers.

FIG. 18 shows an example of two separate gain-equalized green bands in terbium-doped fiber lasers.

FIG. 19 shows an example of two separate gain-equalized green bands in terbium-doped solid-state lasers.

### DETAILED DESCRIPTION OF THE INVENTION

Although reference herein is made primarily to lasers for producing light in green wavelengths, those skilled in the art will recognize that the inventions described in this patent may be applied to lasers for producing light in other wavelength ranges, including, for example, red and blue wavelength ranges.

Those skilled in the art will recognize that the laser medium and dopants used for a given laser greatly affects the reliability, efficiency, and power output, among other factors. In particular, fiber and other solid-state lasers offer practical benefits in terms of reliability and efficiency. While recent work in direct visible fiber lasers has utilized rare earth (RE) dopants such as praseodymium (Pr), dysprosium (Dy), samarium (Sm) and terbium (Tb), for a number of reasons, in at least some embodiments, Tb is a preferable dopant for use with fiber and other solid-state visible lasers. Specifically, as described in U.S. patent application Ser. No. 62/053,491, filed Sep. 22, 2014, the entire contents of which are hereby incorporated by this reference, Tb ions have preferable energy level spacing reducing the transition probability of excited electrons, Tb has desirable absorption characteristics, and Tb ions have emission lines that span a significant range of visible light with regards to visual color discrimination with more accessible visible emission bands than other RE ions.

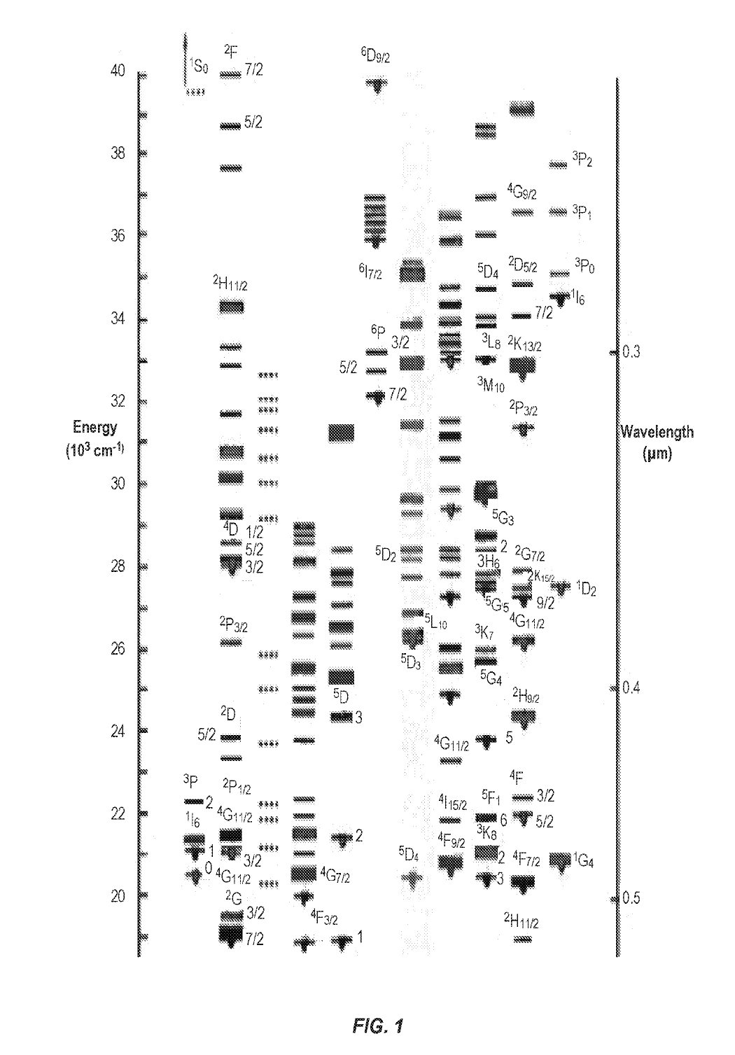

FIG. 1 shows the atomic transition for many of the RE ions, with the right vertical axis showing that most RE ions have some visible emission transitions (optical emission is indicated by semicircles under the energy level marker). As can be seen in FIG. 1, Tb is a good candidate for a lasing RE ion in at least some embodiments, since the ⁵D₄ level is 14 cm⁻¹ above the next lower level. This energy level spacing is larger than all other RE ions with visible optical transitions, and more than twice the energy separation than all other RE ions except europium. FIG. 1 also illustrates that there are more accessible visible emission bands in Tb than in Pr or Dy, such that it can cover a much wider range of the visible spectrum than any other RE element. While Tb is a preferable dopant for several of the embodiments described below, alternative or additional dopants may be employed in other embodiments.

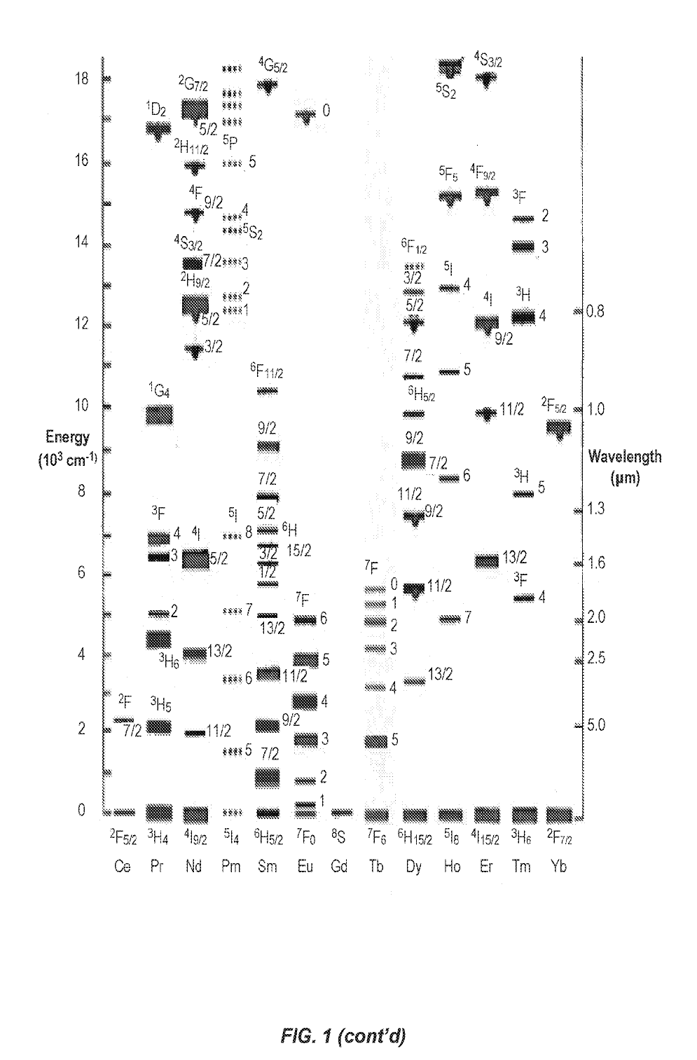

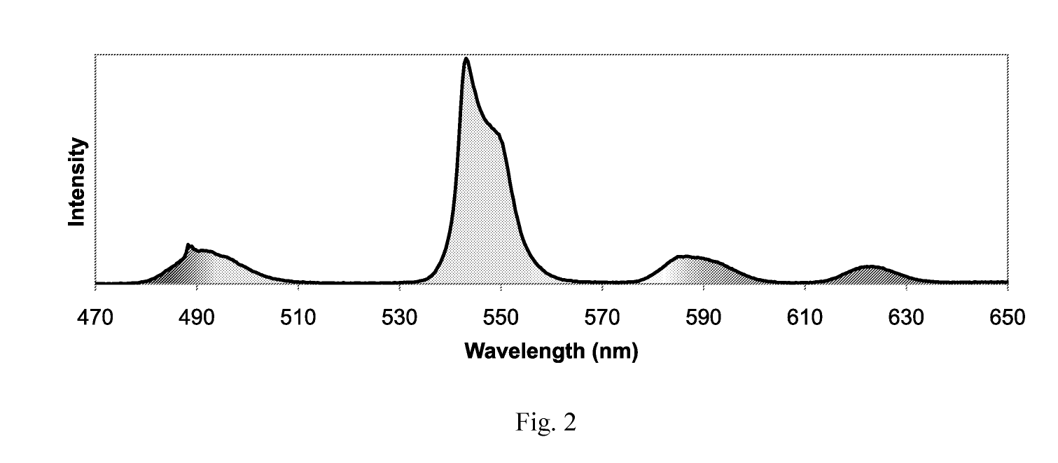

FIG. 2 shows the photoluminescence emission spectrum from a terbium-doped silicate glass when pumped at a wavelength of 488 nm. The area under the curve has been filled in by mapping the optical wavelength to perceptive colors using the CIE 1931 chromacity diagram. FIG. 2 demonstrates that nearly the entire color perceptive scale (except violet) can be achieved using a single gain medium. Those skilled in the art would recognize that this has tremendous implications for high power energy-conserving laser displays.

While these characteristics of Tb suggest that Tb-doped lasers provide for increased reliability, efficiency, and power output, there still exists a need in many instances for reduction of speckle associated with such lasers, such as, for example, lasers used in laser display systems such as DLCs. Accordingly, embodiments are described below that address these needs.

### 1. Broadband Fiber Laser

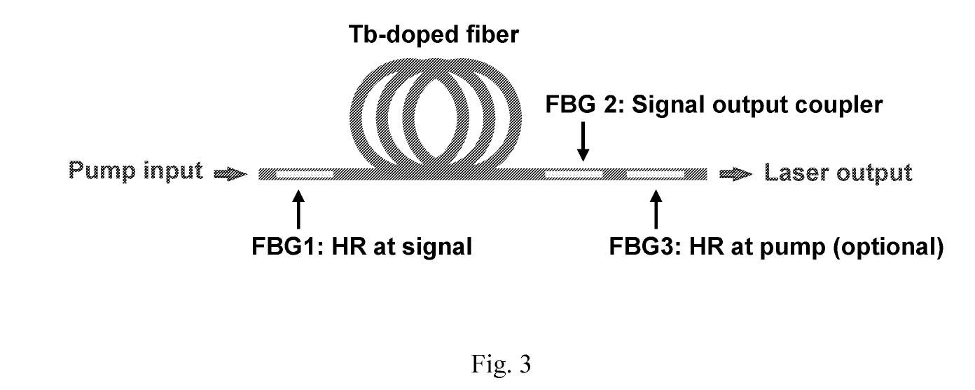

In some embodiments, broadband lasers are provided with reflectors that have a reflection bandwidth suitable for suppressing speckle in laser display systems. For example, a fiber laser with a section of terbium-doped fiber with reflectors on either end of the fiber may be provided. FIG. 3 is one example of a broadband terbium-doped fiber laser. As shown in FIG. 3, a laser cavity includes a Tb-doped fiber core. In some embodiments, the fiber core is a single mode fiber core. At the left end of FIG. 3, a pump input is provided that pumps the laser cavity such that the Tb-doped core emits light. Although shown injecting pump light into only the left end, it will be understood that the pump input may inject pump light into either or both ends of the laser cavity. It will also be understood that the fiber may be either core pumped or cladding pumped, according to methods known to those skilled in the art.

The example in FIG. 3 includes reflectors FBG1, FBG2, and FBG3 that may be designed to have a reflection bandwidth suitable for suppressing speckle. In some embodiments, each of reflectors FBG1-3 is a fiber Bragg grating, which is a spectrally dependent reflector written directly into a fiber. For example, each of FBG1-3 may be written directly into the Tb-doped fiber of the laser illustrated in FIG. 3. In another embodiment, each of FBGs 1-3 are separate optical elements that may be spliced or otherwise integrated with the Tb-doped fiber of the laser illustrated in FIG. 3. In some embodiments, FBG1 is a reflector with high reflectivity in the signal band associated with the laser while transmitting the pump light into the Tb-doped fiber core. For example, FBG1 may have a signal reflectivity of at least 90%. As another example, FBG1 may have a signal reflectivity of at least 98%. In some embodiments, FBG2 is a reflector that acts as an output coupler at the signal band. In some embodiments, the reflectivity of the output coupler may be chosen to optimize the output power and efficiency of the laser. For example, as described in previously incorporated U.S. patent application Ser. No. 62/053,491, the output coupler may be partially reflecting in order to provide feedback to the laser cavity and allow usable power to emit from the laser cavity. Specifically, the reflectivity of the output coupler may be chosen to optimize the intra-cavity power and in turn the output power of the laser, in accordance with embodiments described in previously incorporated U.S. patent application Ser. No. 62/053,491.

As noted above, reflectors FBG1, FBG2, and/or FBG3 may be designed to have a reflection bandwidth suitable for suppressing speckle when the laser is used, for example, in a display system. The reflection bandwidth may be chosen in accordance with the emission bandwidth. For example, for a Terbium emission bandwidth of 10 nm, in one example, the signal reflection bandwidth is greater than 0.5 nm. In another example, signal reflection bandwidth is greater than 5 nm. In one embodiment, the signal reflection band is continuous. In another embodiment, the signal reflection band is not continuous. In some preferred embodiments, where the laser is used to produce green light, for example, for use in a laser display system such as a DLC, the reflection spectrum is near a peak of the green band. For example, the reflection spectrum may include a 545 nm band, which, as shown in FIG. 2 may correspond to a peak of the green band. It will be understood to those of skill in the art that the broadband nature of the reflectors will reduce the coherency of the laser output, and in turn reduce the speckle of the laser output. In some embodiments, it may be desirable to reduce the speckle such that the emitted light of the laser has a speckle contrast of less than 12%.

In one embodiment, the signal reflectors are free-space elements that are coated to provide the desired signal reflection bandwidth. In another embodiment, the signal reflectors are coatings applied directly to the end of the fiber. Although described above in terms of FBGs 1-3, in some embodiments, the signal reflection bandwidth is obtained using a single uniform FBG. In another embodiment, the signal reflection bandwidth is obtained using a single chirped FBG. In yet another embodiment, the signal reflection bandwidth is obtained using a concatenated series of discrete FBGs, either uniform or chirped in nature.

### 2. Multi-Core Fiber Laser

Although described above in terms of a single-core fiber, in some embodiments, instead of a conventional single-core fiber, a multi-core fiber is provided. It will be understood to those skilled in the art that if the cores of a multi-core fiber are sufficiently separated such that the light traveling in one core does not couple into a neighboring core, then each core is effectively a separate fiber laser. In this way, each fiber core can (but does not need to) lase at exactly the same wavelength and still be incoherent, thereby providing speckle-free operation with narrow spectral bandwidth.

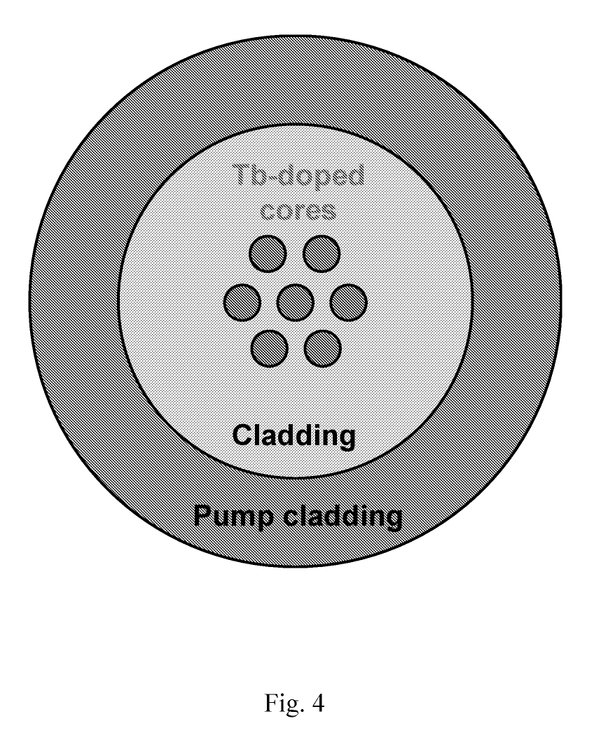

In some preferred embodiments, the multicore fiber is a dual-clad fiber. FIG. 4 shows an example of a cross-section of such a multicore dual-clad Tb-doped fiber laser. In various embodiments, the number of cores can be 3, 7, 19, or more, and can be arranged in standard hex-pack or other configurations as is understood by those skilled in the art. In a preferred embodiment, the outer edge of the cladding is very close to the cores. For example, the distance between the outer edge of the cladding and the cores may be less than 25 μm.

In some embodiments, each of the Tb-doped cores are designed and spaced such that the optical signal power coupling between cores is negligible. In this way, each core functions as a separate laser, and the light emitting from each core is therefore incoherent. This incoherence naturally reduces speckle even though the spectra emitting from each core may be identical and narrowband. In a further embodiment, less than −20 dB of the power in a single core overlaps with a neighboring core. In another embodiment, less than −30 dB of the power in a single core overlaps with a neighboring core.

In some embodiments, the cores are single mode. In other embodiments, each core is few-moded or multimode. In one embodiment, the FBG reflectors in each core are single, uniform FBGs. In one embodiment, the FBG reflectors are all written simultaneously in all cores during one exposure. In another embodiment, separate FBGs are written in each core.

### 3. Broadband Solid-State Laser

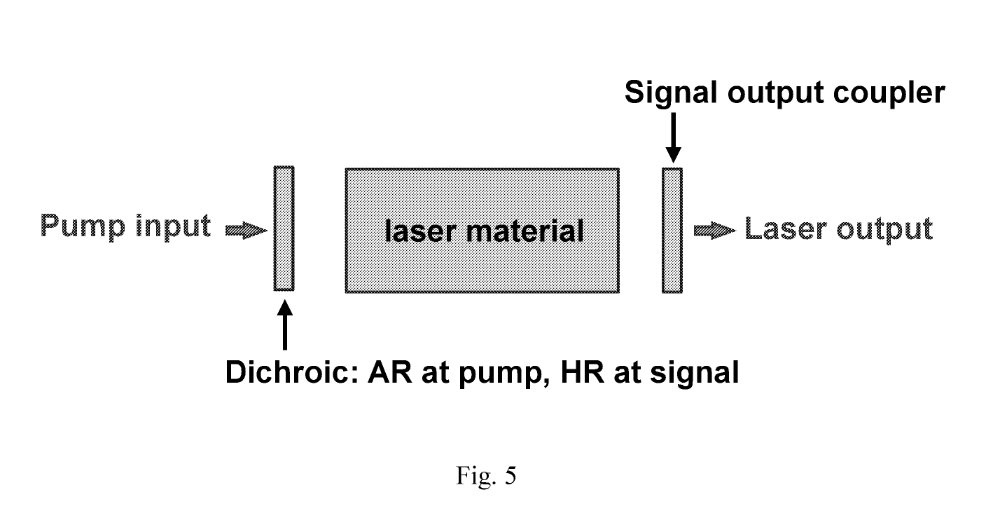

FIG. 5 shows an example of a terbium-doped solid state laser configured to reduce speckle. In at least some embodiments, a solid-state laser has several advantages for display systems. For example, the blue and red bands of a conventional DLC projector are generated directly by semiconductor diode lasers, and the optical output from these lasers is delivered by optical fibers to an integrating rod that spatially mixes the combined laser beams in order to provide a single homogenous output beam. In some embodiments, in the case of a green solid-state laser, the terbium-doped gain medium can be employed as the integrating rod itself, eliminating the need for this additional component. In some embodiments, the delivery fibers can bring pump light from diode lasers very much like the blue and red lasers are brought to their respective integrating rods. In alternative embodiments, the delivery fibers can also be eliminated to save cost, and the diode lasers can pump the terbium gain medium directly.

FIG. 5 shows a terbium-doped solid state laser with reflectors on either side of the terbium-doped solid-state material that define the laser cavity. In some embodiments, the terbium host can be glass, ceramic, or crystalline. As with the fiber laser, a pump input is provided at the left end of FIG. 5 that pumps the laser cavity such that the Tb-doped material emits light. Although shown injecting pump light into only the left end, it will be understood that the pump input may inject pump light into either or both ends of the laser cavity.

In some embodiments, the pump light is injected into the cavity through a dichroic mirror that reflects the signal light but passes the pump light with an antireflection (AR) coating. For example, the dichroic mirror may have signal reflectivity of at least 90%. In a preferred embodiment, the dichroic mirror may have signal reflectivity of at least 98%. On the other end of the cavity, the reflector is an output coupler at the signal band. In some embodiments, the reflectivity of the output coupler may be chosen to optimize the output power and efficiency of the laser. For example, as described in previously incorporated U.S. patent application Ser. No. 62/053,491, the output coupler may be partially reflecting in order to provide feedback to the laser cavity and allow usable power to emit from the laser cavity. Specifically, the reflectivity of the output coupler may be chosen to optimize the intra-cavity power and in turn the output power of the laser, in accordance with embodiments described in previously incorporated U.S. patent application Ser. No. 62/053,491. In a further embodiment, the reflector at the opposite end of the cavity is highly reflective at the pump wavelength to double-pass the pump light in the cavity. In some embodiments, the reflectors are free-space elements. In another embodiment, the reflectors are volume Bragg gratings (VBGs). In yet another embodiment, the reflectors are diffractive optical elements. In a preferred embodiment, the reflectors are coatings applied to the terbium-doped gain element.

As described above with respect to the reflectors of the laser in FIG. 3, the reflectors of the laser in FIG. 5 may be designed to have a reflection bandwidth suitable for suppressing speckle when the laser is used in a display system. Since the terbium emission bandwidth is approximately 10 nm, the reflection bandwidth of the reflectors may be chosen accordingly. In one embodiment, the signal reflection bandwidth is greater than 0.5 nm. In another embodiment, signal reflection bandwidth is greater than 5 nm. In one embodiment, the signal reflection band is continuous. In another embodiment, the signal reflection band is not continuous. In a preferred embodiment, where the laser is used to produce green light, for example, for use in a laser display system such as a DLC, the reflection spectrum is near a peak of the green band. For example, the reflection spectrum may include a 545 nm band, which, as shown in FIG. 2 may correspond to a peak of the green band. It will be understood to those of skill in the art that the broadband nature of the reflectors will reduce the coherency of the laser output, and in turn reduce the speckle of the laser output. As described above, in some embodiments, it may be desirable to reduce the speckle such that the emitted light of the laser has a speckle contrast of less than 12%.

### 4. High-Power Broadband Lasers

In some embodiments, multi-mode lasers are provided to reduce and/or suppress speckle. It will be understood to those skilled in the art that providing for multiple modes within the laser cavity will cause the modes to operate at slightly different wavelengths, such that these modes are mutually incoherent. This incoherency in turn reduces and/or suppresses speckle that might otherwise be associated with a single mode laser.

For example, a fiber laser similar to that described in FIG. 3 may be employed except that the terbium-doped fiber core is a multimode fiber core. In some embodiments, the core supports more than 5 modes. In further embodiments, the core supports more than 10 modes. As described with respect to FIG. 3 above, the terbium-doped fiber core can be pumped either in the core, or in the cladding in an embodiment where the fiber is also dual-clad.

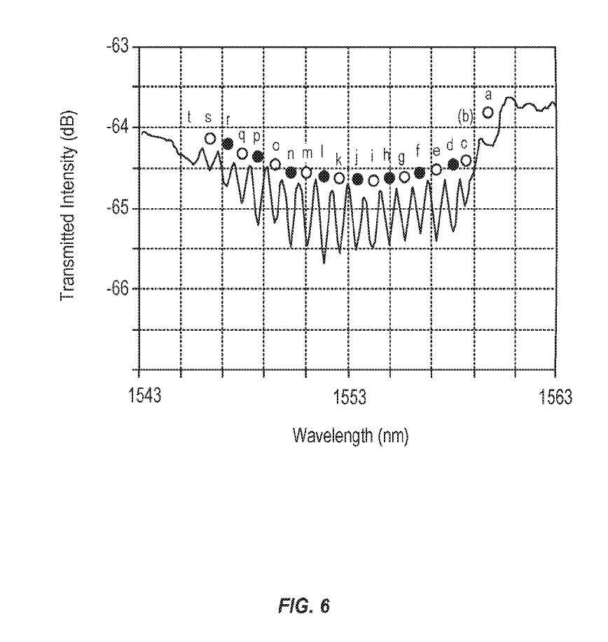

As described above with respect to FIG. 3, in some embodiments, the signal reflectors are FBGs. In a further embodiment, the OC reflector may be a single narrowband FBG. It will be understood by those skilled in the art that FBGs written into multimode fiber exhibit a different spectral reflection for each fiber mode. For example, FIG. 6 illustrates the different spectral reflection peaks for each fiber mode measured by an FBG written in multimode fiber. It will be further understood that since FBGs written into multimode fiber exhibit this different spectral reflection for each mode, each mode will lase at a different wavelength, resulting in natural spectral broadening and speckle reduction.

In some embodiments, the multimode fiber laser may include a reflector having a high signal reflectivity (as described above with respect to FIG. 3). In some embodiments, the reflector with the high signal reflectivity has a broad signal reflection bandwidth as described above with respect to FIG. 3. In another preferred embodiment, the bandwidth of the reflector with high signal reflectivity exceeds the spacing between the center (Bragg) wavelengths of each of the spatial modes of the OC reflector FBG. In a further embodiment, the reflector having a high signal reflectivity is an FBG, as described above with respect to FIG. 3. In a further embodiment, the bandwidth of the reflector having a high signal reflectivity exceeds the spacing between the center (Bragg) wavelengths of each of the spatial modes of the FBG.

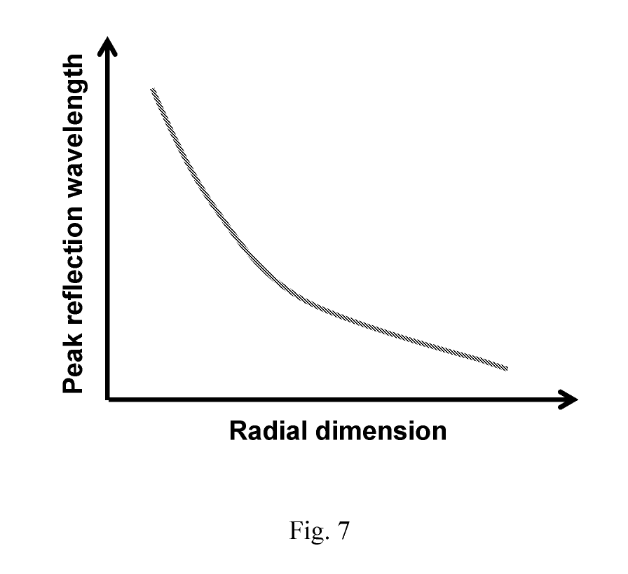

As described above, in some embodiments, the reflector is a coating on the end of the fiber. In accordance with a further embodiment, this coating may be varied radially to provide a different spectral reflection at each radial point on the fiber end. FIG. 7 illustrates how the spectral reflection may vary with the radial dimension in a coating at the end of the fiber in accordance with embodiments of the present invention. As shown in FIG. 7, in a preferred embodiment, the peak reflection wavelength may decrease as the radial dimension increases.

As another example, a multi-mode solid-state laser may also be provided in accordance with embodiments of the present invention. As with the modes of the multi-mode fiber laser described above, a solid-state laser may be configured such that its modes also operate at slightly different wavelengths and are mutually incoherent with each other, resulting in an incoherent, multimode output beam that has naturally reduced or suppressed speckle.

While the multimode solid-state laser may be provided with the broadband reflectors as described in FIG. 5, it will be understood to those of skill in the art that independent lasing modes will lase at slightly different wavelengths, creating a naturally spread spectrum even without a specifically designed broadband coating. It will also be understood to those skilled in the art that in some embodiments, multi-spatial-mode operation may allow for reduced spatial brightness, which in turn, may allow for elimination of the integrating rod common to laser displays.

In some embodiments, the pump distribution of a multi-mode solid-state laser may be designed to allow multiple spatial modes of the laser to experience the nearly the same optical gain even under conditions of high gain saturation. In some embodiments, this may be achieved with an optical system such as a lens system or an LCD. In other embodiments, this may be achieved by radial distribution of the terbium ions in the gain medium. In a further embodiment, the number of modes with similar gain is greater than 5. In another embodiment, the number of modes with similar gain is greater than 10. In a further embodiment, the gain any mode experiences is similar to the gain each other mode experiences to within ±10%. In another embodiment, the gain any mode experiences is similar to the gain each other mode experiences to within ±2%.

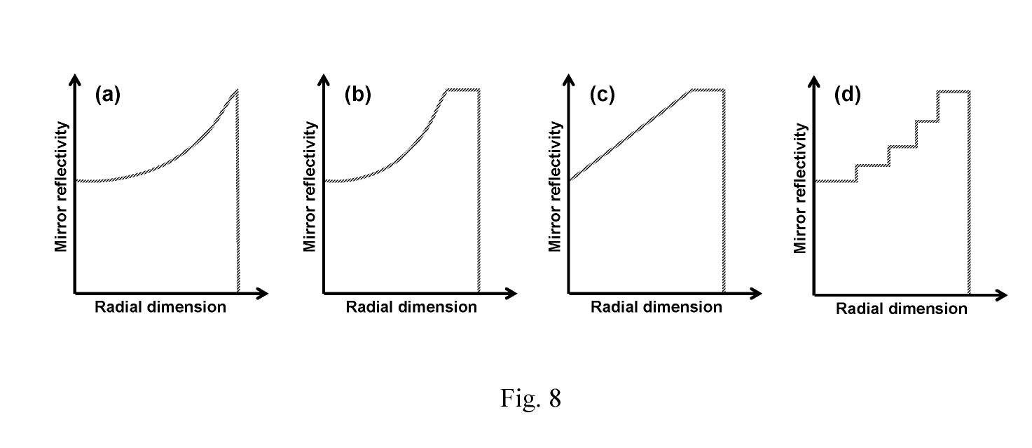

In some embodiments, the multi-mode solid-state laser cavity contains a spatially engineered reflector. In a preferred embodiment, the spatially engineered reflector is the output coupler of the laser. In a further preferred embodiment, the spatially engineered reflector has a radial reflection profile whose reflectivity increases from the center towards the outer edge. FIG. 8 shows examples of radial reflection profiles of a spatially engineered reflector whose reflectivity increases from the center towards the outer edge in accordance with embodiments of the present invention. In one embodiment, the radial reflection profile is represented by a parabolic profile of the form R(r)=R₀×(a+b×r²) similar to FIG. 8(a). In another embodiment, the radial reflection profile is represented by a parabolic profile, except that the outer edge of the reflection profile has a nearly uniform reflectivity as shown in FIG. 8(b). In another embodiment, the radial reflection profile is represented by a linear profile of the form R(r)=R₀×(a+b×r). In another embodiment, the radial reflection profile is represented by a linear profile, except that the outer edge of the reflection profile has a nearly uniform reflectivity similar to FIG. 8(c). In yet another embodiment, the radially increasing reflection profile is represented discretely, as a series of radial steps with increasing reflectivity similar to FIG. 8(d).

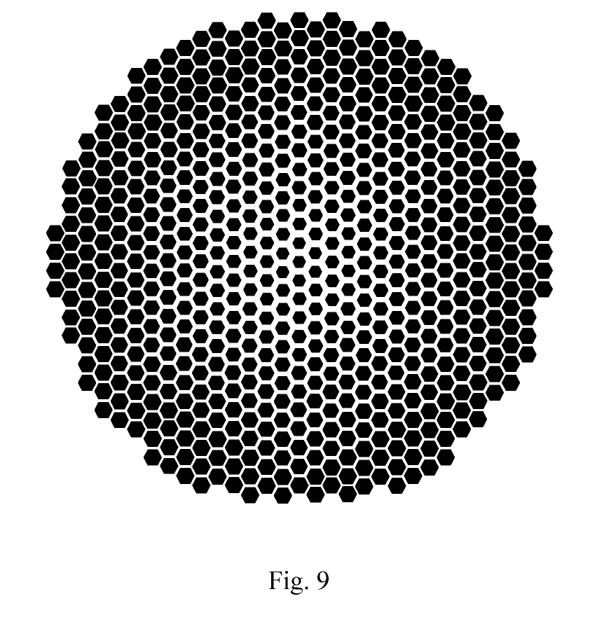

In some embodiments, the spatially engineered reflector is digitally patterned. In a preferred embodiment, the digital pattern is designed such that the azimuthally averaged reflectivity generally increases from the center of the reflector to the edge. In one embodiment, the azimuthally averaged reflectivity digitally approximates a parabolic profile in the radial direction. In another embodiment, the azimuthally averaged reflectivity digitally approximates a linear profile in the radial direction. The patterns can be created using hexagonal, square, or other shapes, and can be randomized in size, shape, and location as known to those skilled in the art. A non-limiting example of a hexagonally digitally patterned reflector with azimuthally averaged reflectivity that increases from the center of the reflector to the outer edge is shown in FIG. 9.

In another embodiment, the multi-mode solid-state laser cavity contains a spatially engineered transmission filter. In a further embodiment, the spatially engineered transmission filter is a pattern on an optical mirror. In one embodiment, the pattern of the spatially engineered transmission filter is designed such that azimuthally averaged transmission generally increases from the center of the reflector to the edge. For example, the azimuthally averaged transmission may approximate a parabolic profile in the radial direction. As another example, the azimuthally averaged transmission may approximate a linear profile in the radial direction. It will be understood to those skilled in the art that the patterns can be created continuously, discretely (e.g., rings), or digitally using hexagonal, square, or other shapes, and can be randomized in size, shape, and location.

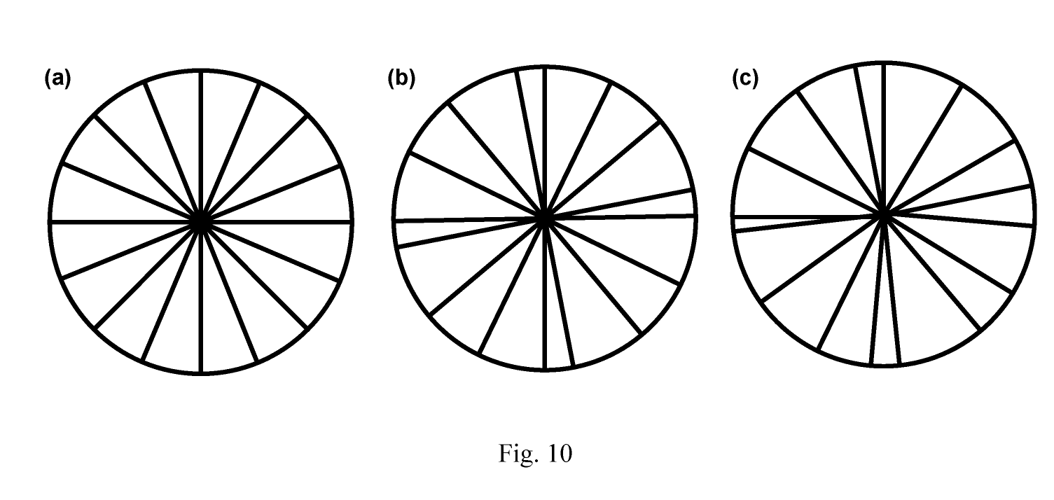

In another embodiment, the spatially engineered transmission filter contains an array of blocking spokes attached from the center of the filter to the edges. FIG. 9 depicts non-limiting examples of spatially engineered transmission filters containing arrays of blocking spokes attached from the center of the filters to the edges in accordance with embodiments of the present invention. In one embodiment, the spokes are arranged uniformly in the azimuthal direction as depicted in FIG. 10(a). In another embodiment, spokes crossing the diameter are arranged randomly as depicted in FIG. 10(b). In yet another embodiment, radial spokes from the center to the edge are arranged randomly as depicted in FIG. 10(c). In another embodiment, the spokes change size from the center of the filter to the edges.

In some embodiments, the multi-mode solid-state laser cavity may contain a wavelength-selective element whose wavelength dependence changes with spatial position. The positional wavelength dependence forces neighboring spatial modes to operate at different wavelengths, enforcing incoherence and speckle reduction. In one embodiment, the radial wavelength dependence is incorporated using a coating that is varied radially to provide a different spectral reflection at each radial point on the optic. In a preferred embodiment, the optimal wavelength increases from the center of the element to its edge. In one embodiment, the element provides wavelength-dependent reflection. In another embodiment, the element provides wavelength-dependent transmission.

Although described above separately, it will be understood to those skilled in the art that any or all of the spatially engineered reflectors, spatially engineered transmission filters, and wavelength-selective elements may be used in combination in accordance with embodiments of the present invention.

### 5. Fourier Transform Solid-State Laser

While multi-mode lasers as described above can result in mutual incoherence if each mode lases at slightly different wavelengths, in some instances, various mechanisms within the multi-mode laser cavity may cause light to be coupled between spatial modes, inducing coherence by lasing at the same wavelength. Accordingly, embodiments are disclosed for reducing the coupling between spatial modes and maintaining the incoherency of spatial lasing modes.

One of the prominent mechanisms that couples light between spatial modes in high-efficiency lasers is the optical gain itself. It has been shown that the presence of optical gain introduces a change in the refractive index of the medium. In the case of multimode operation, such changes can cause coupling between the modes. Especially considering the effect of gain saturation during multimode operation, the process will not likely reach a steady state, and the process can only be described by coupling between modes of the original resonator (i.e., without including gain-induced index changes).

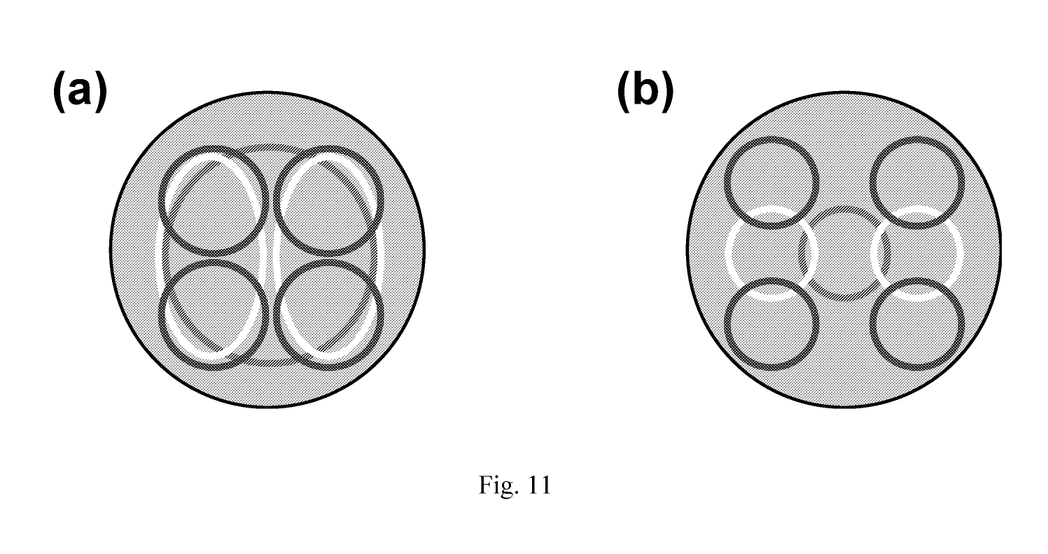

A conventional laser resonator is often designed to produce stable propagating beams within the cavity by using methods known to those skilled in the art. These beams are often described as Hermite-Gaussian, Laguerre-Gaussian, and Bessel-Gaussian, depending on the specific resonator geometry. In a typical multimode resonator, the modes will spatially overlap in the gain medium. This situation is depicted in FIG. 11(a), which shows a transverse cross section of beams of different spatial modes inside a conventional multimode laser. The spatial patterns of mode intensities are represented by only colored outlines for simplicity to highlight the overlap characteristics of the modes. Each mode shown is represented by a single color (red, yellow, or blue). Since the mode intensity profiles significantly (typically >75%) overlap within the gain medium, they can couple strongly through the gain mechanism described previously.

In accordance with some embodiments of the present invention, in order to reduce coupling, the laser cavity beams are Fourier transformed before entering the gain medium. Since the higher-order modes have increasingly fine spatial structure, their spatial frequencies (defined by the Fourier transforms of the modes) are distinctly different. The physical (optical) Fourier transform (FT) of an optical beam can be generated by using a simple lens. If all of the modes are subject to the same Fourier-transform process by the same lens, their spatial frequencies will physically manifest in the FT plane of the imaging system. Having distinctly different spatial frequencies means that the beams in the FT plane are spread out from each other and do not overlap significantly. Placing the laser gain medium at this FT plane means that each mode (in the FT plane) has significantly reduced spatial overlap, as depicted in FIG. 11(b), and therefore significantly reduced coupling between the modes through the gain mechanism described previously. With the coupling between modes significantly reduced, each spatial mode in the resonator will lase independent of the rest, resulting in an incoherent multimode optical beam emitting from the laser cavity. It will be understood by those skilled in the art that this incoherent beam will be inherently free from speckle in spite of the fact that it can be extremely spectrally narrowband.

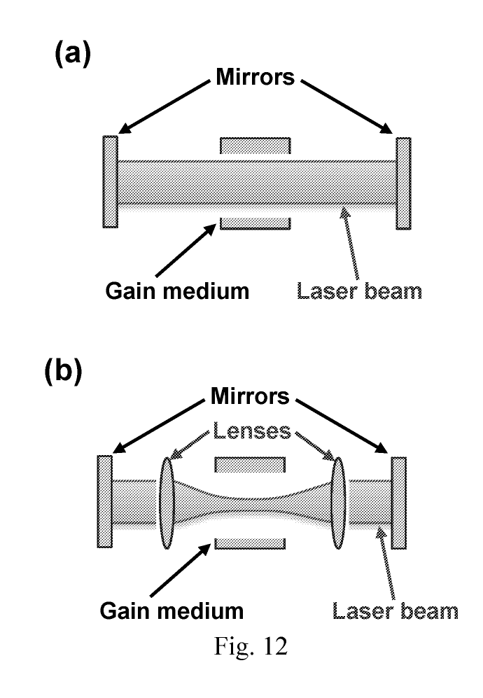

FIG. 12(a) shows a simplified depiction of a typical solid-state laser resonator cavity. As can be seen in FIG. 12(a) the laser beam in the cavity is formed by two or more mirrors. As known to those skilled in the state of the art, sufficient curvature inherent to one or more of the mirrors can create a stable oscillator configuration, including compensation of thermal lensing, or result in an unstable resonator by design. FIG. 12(b) shows a simplified depiction of an FT laser in accordance with embodiments of the present invention. In the FT laser, as shown in FIG. 12(b), a set of imaging optics is placed around the gain medium to produce an axial portion of the cavity that is represented by Fourier space in order to provide reduced overlap between the modes in the gain medium.

In some embodiments, an imaging system is added to a conventional solid-state laser cavity to create an axial region within the cavity that is largely defined by those skilled in the art as “Fourier transform space.” In this FT axial region, the optical field is generally represented as the Fourier transform of the beam outside of this FT axial region. In a preferred embodiment, the gain medium is placed within this FT axial region. In yet a further embodiment, the gain medium is placed at the Fourier transform plane.

In some embodiments, the imaging elements of the imaging system are lenses. In other embodiments, the imaging elements are curved mirrors. In still other embodiments, the imaging elements are diffractive optical elements.

In some embodiments, the laser cavity is a symmetric folded cavity. In further embodiments, the gain medium is placed at the fold (symmetry) point. In yet further embodiments, the fold (symmetry) point is inside the FT axial region. In yet further embodiments, the fold (symmetry) point is precisely in the center of the FT axial region.

In some embodiments, the gain medium is a solid-state thin disk. In another embodiment, the gain element is a semiconductor gain element. In a further embodiment, the semiconductor gain element is used as a vertical external cavity surface emitting laser (VECSEL).

### 6. High-Power Solid-State Laser

As described above, many laser applications, including laser display applications such as DLCs require high power operation. Accordingly, embodiments are described for scaling lasers described herein for high power operation.

In some embodiments, high power operation may be achieved by surrounding the laser gain material by a cladding material. In a preferred embodiment, the cladding material has low absorption at visible wavelengths. For example, the cladding may be made of glass material. As another example, the cladding may be made of a ceramic material. In yet another example, the cladding may be made of a crystalline material.

In some embodiments, the gain material and cladding material form an optical waveguide. In a preferred embodiment, the waveguide supports multiple transverse modes. In a further embodiment, the waveguide supports more than 5 transverse modes. In another embodiment, the waveguide supports more than 10 transverse modes.

In some embodiments, high power operation may be achieved by coating the outside of the cladding with metal in order to remove heat. In another embodiment, heat removal may be effected by using a liquid as the cladding material. In a further embodiment, the cladding material is a flowing liquid. It will be understood to those with skill in the art that a liquid cladding not only confines the pump light, but also functions as a heat exchanger.

In some embodiments, high power operation may be achieved by surrounding the cladding by a pump cladding. In further embodiments, the pump cladding has a numerical aperture greater than 0.10. In another embodiment, the pump cladding has a numerical aperture greater than 0.20. It will be understood by those with skill in the art that increased numerical aperture allows more pump light to be coupled, thus allowing for higher output power of the laser. In some embodiments, the pump cladding has a cross-sectional area that is less than 10% larger than that of the gain material. It will be understood by those with skill in the art that a decreased cross-sectional area results in higher pump intensity and more efficient conversion.

In some embodiments, high power operation may be achieved by coupling the pump into the gain material. In other embodiments, the pump is coupled into the cladding material. In another embodiment, the pump is coupled into both the gain and cladding materials.

### 7. Bandwidth-Enhanced Lasers

As noted above with respect to the lasers described in FIGS. 3 and 5, lasers with reflectors with a broadened bandwidth provide reduced speckle in laser display systems. Since some gain mediums do not inherently provide for uniform gain across desired bands of wavelengths of light, embodiments for compensating portions of the varied gain are provided.

By way of example, the gain produced by Tb ions in a Tb-doped laser has a spectral dependence such that all wavelengths in the green band do not experience the same gain propagating in the Tb-doped gain medium. To address such spectral dependence, in accordance with embodiments of the present invention, a spectral shaping element is added to the laser cavity to compensate the spectrally shaped gain. In this way, the net gain in the cavity is relatively flat across some portion of a band of interest. In some embodiments, the flatness is ±10% over the band of interest. In other embodiments, the flatness is ±2% over the band of interest.

In some embodiments, the spectral shaping element is an intra-cavity filter. In other embodiments, where the laser is a fiber laser, the spectral shaping element is a coating on the end of the fiber. In a preferred embodiment where the laser is a fiber laser, the spectral shaping is provided by FBGs. In some embodiments, where the laser is a solid-state laser, the spectral shaping element is a coated mirror. In other embodiments where the laser is a solid-state laser, the spectral shaping element is a coating on the end of the gain element. In yet other embodiments where the laser is a solid-state laser, the spectral shaping element is a VBG.

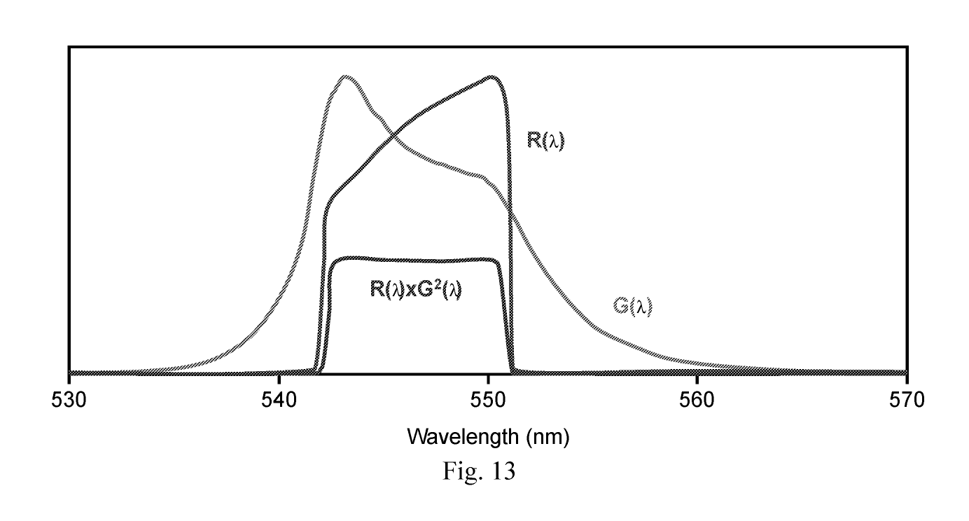

As described above, in a preferred embodiment for fiber lasers, the spectral shaping is provided by FBGs of the fiber laser. In some embodiments, the spectral shaping is provided by the signal FBGs of the resonator (HR and OC, as described with respect to FIG. 3). The gain produced by the terbium ions has a spectral dependence such that a single-pass through the medium yields a power gain of G(□). The combined set of signal-reflectors have a spectral dependence R(□)=R_{HR}(□)×R_{OC}(□) for the optical power. In this embodiment, the set of signal-band reflectors provides a reflection spectrum for equalization such that the net round trip gain R(□)×G²(□) is nearly uniform over some portion of the green band. A non-limiting example is conceptually shown in FIG. 13, where the net round trip gain R(□)×G²(□) is nearly uniform over a desired range of wavelengths. For example, the desired range of wavelengths may include 535-560 nm, which corresponds to a portion of the green band. In a preferred embodiment, this nearly uniform region is near the peak of the green band. In a preferred embodiment, the spectral shaping element is the OC FBG.

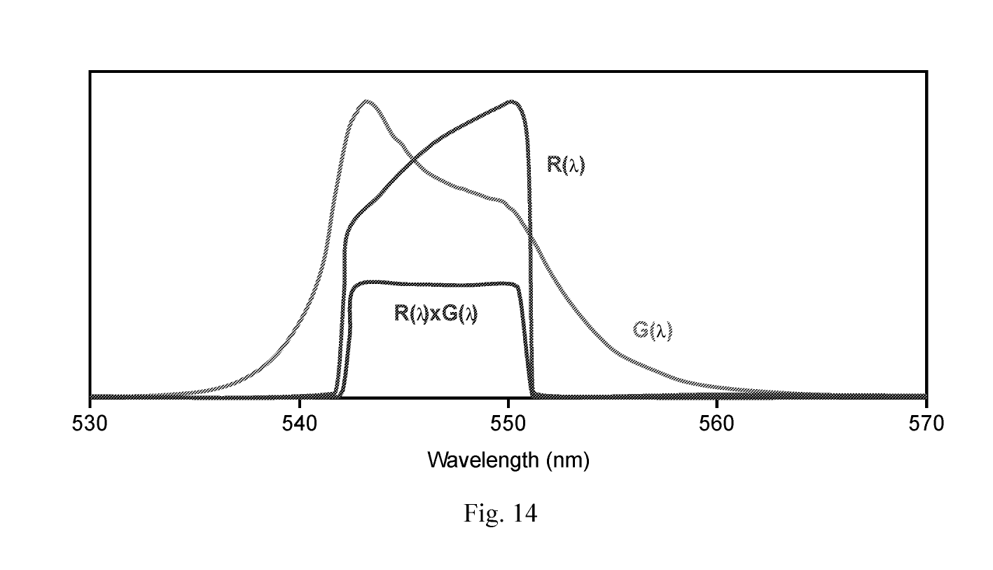

Similarly, with respect to a solid-state laser, in a preferred embodiment, the spectral shaping is provided by the signal reflectors of the resonator. The gain produced by the terbium ions has a spectral dependence such that passing through the medium in a full round trip of the cavity yields a gain of G(□). The combined set of signal-band reflectors providing a round trip through the cavity has a spectral dependence R(□) for the optical power. In this embodiment, the set of signal-band reflectors provides a reflection spectrum for equalization such that the net round-trip cavity gain R(□)×G(□) is nearly uniform over some portion of the green band. A non-limiting example is conceptually shown in FIG. 14, wherenet round-trip cavity gain R(□)×G(□) is nearly uniform over a desired range of wavelengths. For example, the desired range of wavelengths may include 535-560 nm, which corresponds to a portion of the green band. As with the fiber laser embodiment described above, in a preferred embodiment, this nearly uniform region is near the peak of the green band. In another preferred embodiment, the spectral shaping element is the OC reflector of the cavity.

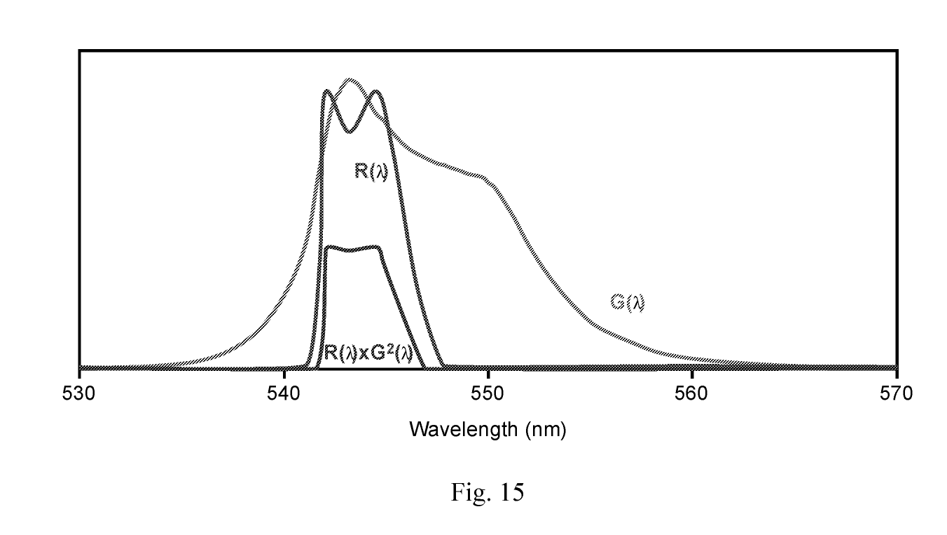

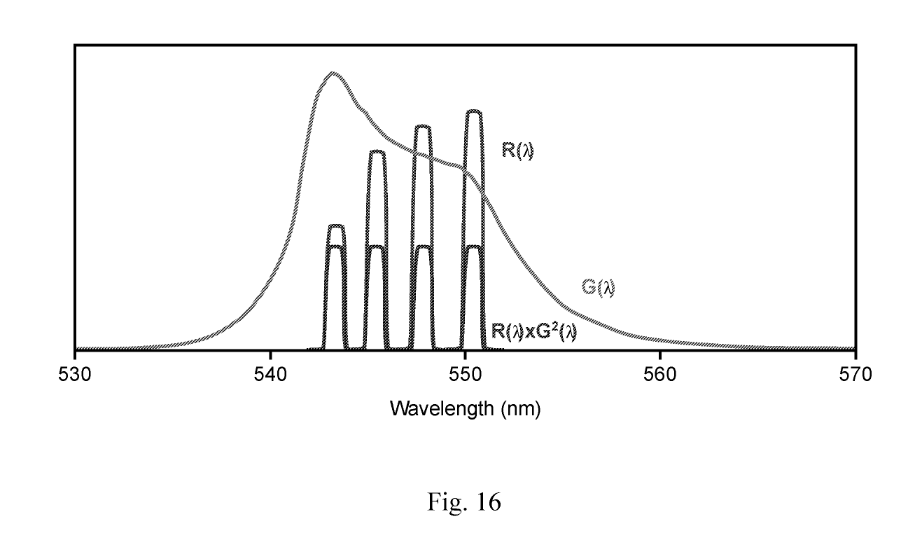

In some embodiments, the flattened bandwidth (for either the fiber or solid-state embodiments described above) is only near the gain peak, depicted in FIG. 15. In other embodiments, multiple concatenated FBGs (in the case of fiber lasers) or multiple-banded coatings on a single optic, or single-banded coatings on multiple optics (in the case of solid-state lasers) are used to provide a discretely broadened emission spectrum, as depicted in FIG. 16.

In embodiments using an intra-cavity filter in a solid state laser, the filter has transmission dependence T(□) such that the net single-pass gain T(□)×G(□) is nearly uniform over some portion of the green band.

In some embodiments, a combination of transmission and reflection elements are used in a fiber laser to provide a net cavity round trip gain R(□)×T²(□)×G²(□) that is nearly uniform over the band(s) of interest. In some embodiments, a combination of transmission and reflection elements are used in a solid-state laser to provide a net cavity round trip gain R(□)×T(□)^{x} G(□) that is nearly uniform over the band(s) of interest.

Those skilled in the art will recognize that this can be applied to other types of laser cavities, for example ring resonators, by making equalizing the round trip gain nearly uniform by using spectrally dependent reflectors and filters. In this case, the round-trip functions for reflection, filter transmission, and gain, R_{RT}(□), T_{RT}(□), and G_{RT}(□), respectively, result in a net gain uniformity condition on the quantity R_{RT}(□)×T_{RT}(□)×G_{RT}(□).

### 8. Band-Edge Lasers

As described above, high-power, speckle-free lasers are particularly desirable for use in digital laser displays such as DLCs. Some digital laser displays such as DLCs are used to project 3D movies, and the current primary method for projecting 3D movies in DLC is to use two nearby wavelengths in each of the three relevant color bands, i.e., two red wavelengths, two green wavelengths, and two blue wavelengths. To view the 3D images, the viewer wears 3D glasses with two separate lenses (one in the left, and one in the right, for example). Each lens in the 3D glasses has a color filter to allow one red/green/blue set of wavelengths pass while blocking the other. In this way, both sets of RBG wavelengths are projected, but only one set is seen by each of the viewer's eyes. In view of this growing use, it is desirable to generate two distinctly separate bands within a given range of wavelengths for use in the aforementioned color-split 3D DLC projectors. Accordingly, embodiments for selecting two separate bands in a laser are provided.

Since the terbium gain bandwidth is sufficiently large, two separate spectral selectors may be used, for example, to generate the two green colors usable in color-split 3D DLC projectors. They can be spectrally located with the desired separation at two different points on the terbium gain spectrum. In one embodiment, the spectral selectors are intra-cavity filters. In other embodiments, the spectral selectors are coatings on the end of the fiber or other gain material. In yet another embodiment, the spectral reflectors are volume Bragg gratings (VBGs). In some embodiments, the spectral selectors are FBGs. In a further embodiment, the FBGs are apodized to eliminate spectral side lobes.

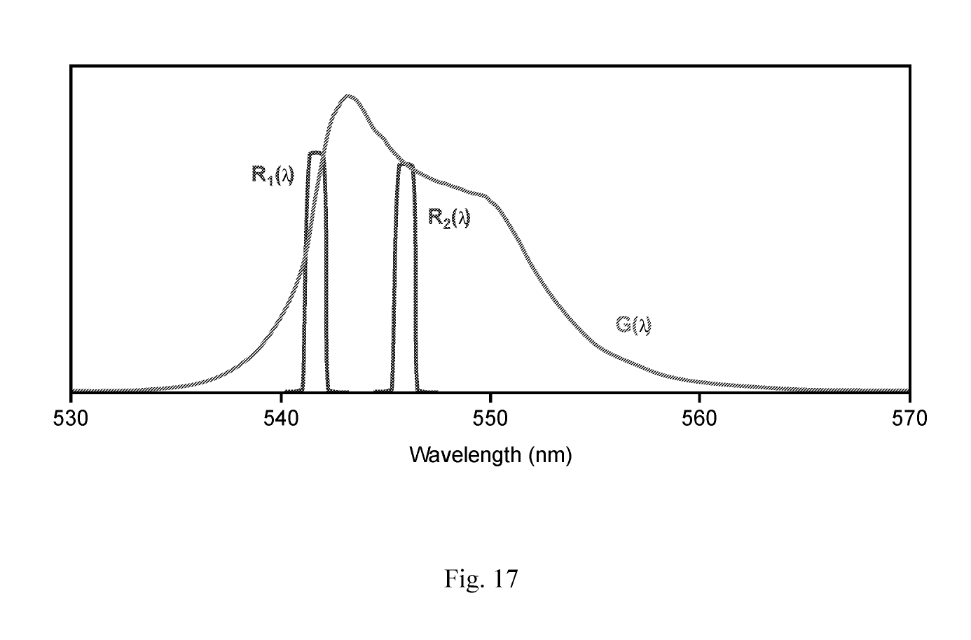

FIG. 17 illustrates an example where the two different spectral selectors are reflectors R₁(□) and R₂(□). In one embodiment, the two green colors are generated in separate lasers. In another embodiment, the two green colors are generated in the same laser.

In another embodiment, spectral shaping elements such as those described above with respect to FIGS. 13-16 are designed to compensate the gain spectrum. In this way, the net gain in the cavity is relatively flat for each color across some portion of the green band. In one embodiment, the flatness is ±10% over each band of interest. In another embodiment, the flatness is ±2% over each band of interest.

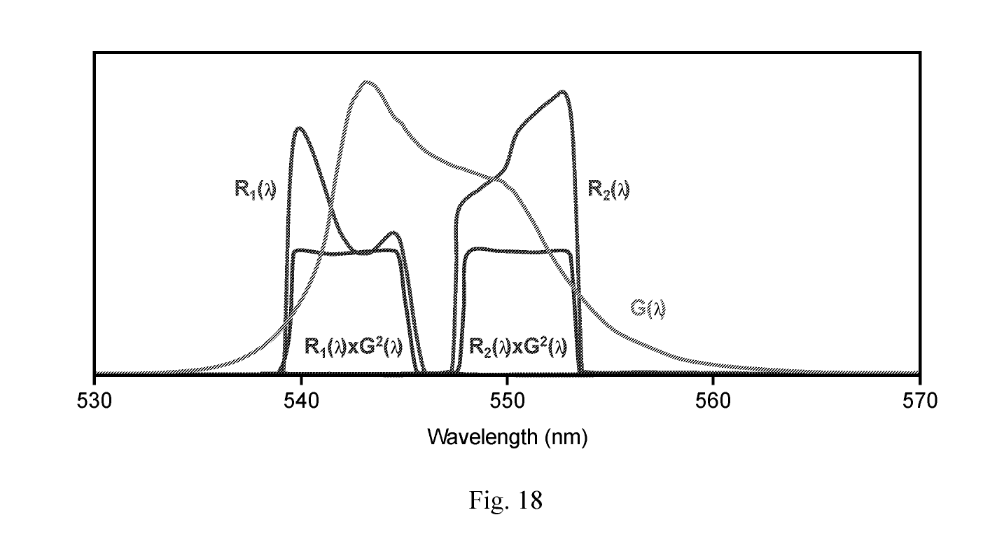

In some embodiments, where the laser is a fiber laser, the spectral selectors are the HR and OC reflectors of the cavity. In a preferred embodiment, the spectral selectors are the OC reflectors. FIG. 18 shows a non-limiting example of how to select two separate sets of signal-reflectors with a spectral dependence R₁(□)=R_{1,HR}(□)×R_{1,OC}(□) and R₂(□)=R_{2,HR}(□)×R_{2,OC}(□). Each set of signal reflectors provides gain such that R₁(□)×G²(□) and R₂(□)×G²(□) are each nearly uniform over different portions of the green band. In one embodiment where the two colors are generated by the same laser, the quantity [R₁(□)+R₂(□)]×G²(□) is nearly uniform over both bands of interest.

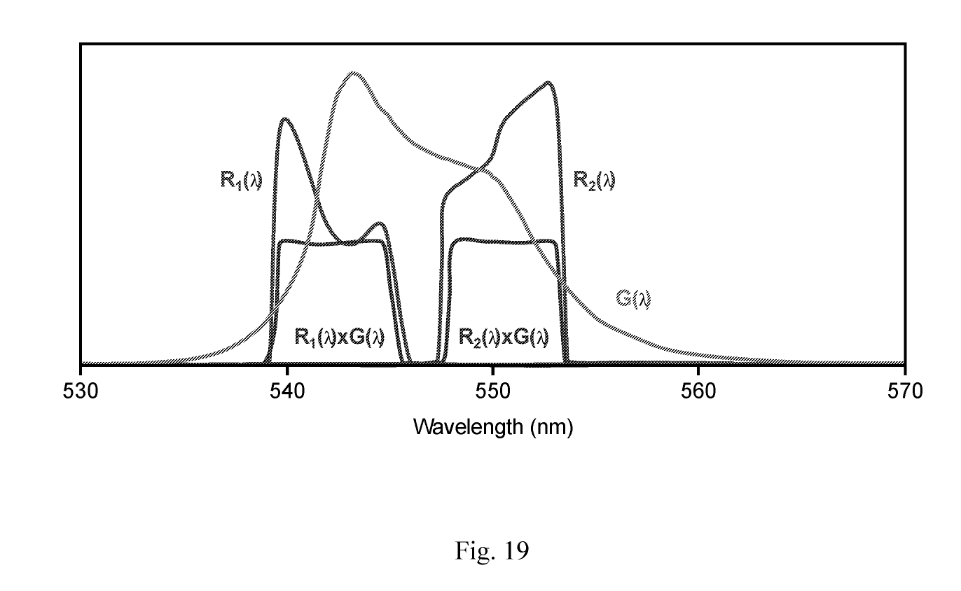

In some embodiments, where the laser is a solid-state laser, the spectral selectors are the cavity reflectors. FIG. 19 shows a non-limiting example of how to select two separate sets of signal-reflectors with a combined round-trip spectral dependence R₁(□) and R₂(□). Each set of signal reflectors provides gain such that R₁(□)×G(□) and R₂(□)×G(□) are each nearly uniform over different portions of the green band. In one embodiment where the two colors are generated by the same laser, the quantity [R₁(□)+R₂(□)]×G(□) is nearly uniform over both bands of interest.

In a preferred embodiment, the spectral selectors are the OC reflectors of the laser cavity. In other embodiments, multiple concatenated FBGs (in the case of fiber lasers) or or multiple-banded coatings on a single optic, or single-banded coatings on multiple optics (in the case of solid-state lasers) are used to provide discretely broadened emission spectra in each green color band.

In an embodiment using an intra-cavity filter, the filter has transmission dependence T(□) such that the net gain T(□)×G(□) is nearly uniform over some portion of the green band.

In some embodiments, a combination of transmission and reflection elements are used in a fiber laser to provide a net cavity round trip gain R_{RT}(□)×T_{RT}(□)×G_{RT}(□) that is nearly uniform of the band(s) of interest. In some embodiments, a combination of transmission and reflection elements are used in a solid-state laser to provide a net cavity round trip gain R(□)×T(□)×G(□) that is nearly uniform of the band(s) of interest.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A laser, comprising:
a laser cavity comprising a terbium-doped lasing material;
a first reflector positioned at a first end of the laser cavity;
an output coupler positioned at a second end of the laser cavity; and
a pump configured to pump the laser cavity such that the terbium-doped lasing material emits light.

2. The laser of claim 1, wherein the laser is a fiber laser.

3. The laser of claim 2, wherein the first reflector comprises a reflectivity of at least 90% for at least some wavelengths of the emitted light.

4. The laser of claim 3, wherein the first reflector comprises a reflectivity of at least 98% for at least some wavelengths of the emitted light.

5. The laser of claim 2, wherein the first reflector comprises a signal reflection bandwidth greater than 0.5 nm.

6. The laser of claim 5, wherein the first reflector comprises a signal reflection bandwidth greater than 5 nm.

7. The laser of claim 6, wherein the first reflector comprises a signal reflection bandwidth greater than 5 nm and less than 15 nm.

8. The laser of claim 7, wherein the signal reflection bandwidths include a 545 nm band.

9. The laser of claim 7, wherein the emitted light comprises a bandwidth greater than 5 nm and less than 15 nm.

10. The laser of claim 1, wherein the laser is a multi-core fiber laser comprising a plurality of spaced apart terbium-doped fiber cores.

11. The laser of claim 10, wherein the plurality of terbium-doped fiber cores are spaced apart such that less than −20 dB of the power of one of the cores overlaps with a neighboring core.

12. The laser of claim 1, wherein the terbium-doped lasing material comprises a multimode fiber core.

13. The laser of claim 12, wherein the output coupler comprises a fiber Bragg grating configured such that different modes of the multimode fiber core lase at different wavelengths.

14. The laser of claim 12, wherein at least a first mode of the multimode fiber core is configured to lase at a first wavelength, a second mode of the multimode fiber core is configured to lase at a second wavelength different from the first wavelength, and a third mode of the multimode fiber core is configured to lase at a third wavelength different from the first and second wavelengths.

15. The laser of claim 14, wherein the first reflector comprises a signal reflection bandwidth including the first, second and third wavelengths.

16. The laser of claim 12, wherein the first reflector comprises a spectral reflection that spatially varies.

17. The laser of claim 1, wherein the laser is a solid-state laser.

18. The laser of claim 17, wherein the lasing material comprises one of a glass, a ceramic, and a crystalline material.

19. The laser of claim 17, wherein the first reflector comprises a reflectivity of at least 90% for at least some wavelengths of the emitted light.

20. The laser of claim 19, wherein the first reflector comprises a reflectivity of at least 98% for at least some wavelengths of the emitted light.

21. The laser of claim 17, wherein the first reflector comprises a signal reflection bandwidth greater than 0.5 nm.

22. The laser of claim 21, wherein the first reflector comprises a signal reflection bandwidth greater than 5 nm.

23. The laser of claim 22, wherein the first reflector comprises a signal reflection bandwidth greater than 5 nm and less than 15 nm.

24. The laser of claim 23, wherein the signal reflection bandwidths include a 545 nm band.

25. The laser of claim 23, wherein the emitted light comprises a bandwidth greater than 5 nm and less than 15 nm.

26. The laser of claim 17, wherein the laser is a multimode solid-state laser.

27. The laser of claim 26, wherein the output coupler is configured such that different modes of the multimode laser lase at different wavelengths.

28. The laser of claim 26, wherein at least a first mode of the multimode solid-state laser is configured to lase at a first wavelength, a second mode of the multimode solid-state laser is configured to lase at a second wavelength different from the first wavelength, and a third mode of the multimode solid-state laser is configured to lase at a third wavelength different from the first and second wavelengths.

29. The laser of claim 28, wherein the first reflector comprises a signal reflection bandwidth including the first, second and third wavelengths.

30. The laser of claim 26, wherein the output coupler comprises a spectral reflection that spatially varies.

31. The laser of claim 30, wherein the spectral reflection of the output coupler increases from a centerpoint of the output coupler towards an outer edge of the output coupler.

32. The laser of claim 31, wherein the spectral reflection is digitally patterned to increase from the centerpoint towards the outer edge, wherein the spectral reflection comprises an azimuthally averaged spectral reflection.

33. The laser of claim 26, further comprising a transmission filter that spatially varies.

34. The laser of claim 33, wherein the transmission filter comprises a pattern on an optical mirror.

35. The laser of claim 33, wherein the transmission filter comprises an array of a plurality of spokes attached at the center of the filter and extending to an outer edge of the filter, wherein the spokes block transmission of particular wavelengths of light, and wherein the size of each of the plurality of spokes increases from the center of the filter to the outer edge of the filter.

36. The laser of claim 26, further comprising at least one imaging element configured to transform beams of light in the laser cavity so as to reduce coupling between different modes of the multimode laser.

37. The laser of claim 36, wherein the at least one imaging element is configured to Fourier transform beams of light in the laser cavity.

38. The laser of claim 37, wherein the at least one imaging element comprises at least one of a lense, a curved mirror, and a diffractive optical element.

39. A laser, comprising:
a laser cavity comprising a terbium-doped lasing material, the terbium-doped lasing material comprising a spectrally dependent variable gain; and
a spectral shaping element configured to compensate at least a portion of the spectrally dependent variable gain of the lasing material.

40. The laser of claim 39, wherein the spectral shaping element is at least one of an intra-cavity filter, a coating on an end of an optical fiber, or a fiber Bragg grating.

41. The laser of claim 39, wherein the spectral shaping element comprises a fiber Bragg grating reflector positioned at a first end of the laser cavity and a fiber Bragg grating output coupler positioned at a second end of the laser cavity.

42. The laser of claim 39, wherein the spectral shaping element is configured to compensate at least a portion of spectrally dependent variable gain of the lasing material such that a net gain of the lasing material is substantially uniform over a band of wavelengths of interest.

43. The laser of claim 42, wherein the band of wavelengths of interest is 535-560 nm.

44. The laser of claim 42, wherein the band of wavelengths of interest corresponds to a peak of the spectrally dependent variable gain.

45. The laser of claim 39, further comprising a plurality of spectral shaping elements, wherein each of the plurality of spectral shaping elements is configured to compensate a respective portion of the spectrally dependent variable gain of the lasing material such that a net gain of the lasing material is substantially uniform over a band of wavelengths of interest.

46. The laser of claim 39, wherein the laser is a solid-state laser, and wherein the spectral shaping element is at least one of an intra-cavity filter, a coating on an end of the lasing material, or a volume Bragg grating.

47. A laser system, comprising:
at least one laser cavity comprising a terbium-doped lasing material, the terbium-doped lasing material comprising a gain bandwidth;
a first spectral selector element configured to generate a first band from the gain bandwidth;
a second spectral selector element configured to generate a second band from the gain bandwidth, the second band being distinct from the first band.

48. The laser system of claim 47, wherein the system comprises:
a first laser comprising the at least one laser cavity and the first spectral selector; and
a second laser comprising a second laser cavity comprising a terbium-doped lasing material, and the second spectral selector.

49. The laser system of claim 47, wherein each of the spectral selector elements is at least one of an intra-cavity filter, a coating on an end of an optical fiber, a fiber Bragg grating, or a volume Bragg grating.

50. The laser system of claim 47, wherein the terbium-doped lasing material comprises a spectrally dependent variable gain, and wherein the laser system further comprises:
a first spectral shaping element configured to compensate at least a first portion of the spectrally dependent variable gain of the lasing material such that a net gain of the lasing material is substantially uniform over the first band; and
a second spectral shaping element configured to compensate at least a second portion of the spectrally dependent variable gain of the lasing material such that a net gain of the lasing material is substantially uniform over the second band.

51. The laser system of claim 47, wherein the laser system is configured to be used in a digital laser display for reproducing three-dimensional images.

52. A digital laser display comprising:
a plurality of lasers usable to display images, wherein each of the plurality of lasers is configured to emit light within a distinct band of wavelengths;
wherein at least one of the plurality of lasers comprises:
a laser cavity comprising a terbium-doped lasing material;
a first reflector positioned at a first end of the laser cavity;
an output coupler positioned at a second end of the laser cavity; and
a pump configured to pump the laser cavity such that the terbium-doped lasing material emits light within a desired band of wavelengths, wherein the emitted light has a speckle contrast of less than 12%.

53. The digital laser display of claim 52, wherein the desired band of wavelengths is 535-560 nm.
